(19) United States
(12) Patent Application Publication
(10) Pub. No.: US 2022/0399030 A1
(43) Pub. Date: Dec. 15, 2022

(54) Systems and Methods for Voice Based Audio and Text Alignment

(71) Applicant: Shijian Tech (Hangzhou) Co., Ltd., Zhajiang Province (CN)

(72) Inventors: Changyin Zhou, Zhejiang Province (CN); Fei Yu, Zhejiang Province (CN)

(21) Appl. No.: 17/450,913

(22) Filed: Oct. 14, 2021

(30) Foreign Application Priority Data
Jun. 15, 2021 (CN) 202110658488.7

(51) Int. Cl. G10L 21/04; G10L 25/51; G10L 25/30; G10L 13/08

(52) U.S. Cl. CPC G10L 21/04; G10L 25/51; G10L 25/30; G10L 13/08

(57) ABSTRACT

The present disclosure relates to systems and methods for temporally aligning media elements. Example methods include providing an audio input waveform based on an audio input and receiving a text input. The example method also includes converting the text input to a text-to-speech input waveform and extracting, with an audio feature extractor, characteristic audio features from the audio input waveform and the text-to-speech input waveform. The example method yet further includes comparing audio input waveform features and text-to-speech waveform features and, based on the comparison, temporally aligning a displayed version of the text input with the audio input.

### CROSS REFERENCE TO RELATED APPLICATION

This application claims priority to Chinese Patent Application No. 202110658488.7, filed Jun. 15, 2021, the content of which is incorporated herein by reference in its entirety.

### BACKGROUND

Temporal alignment of various media elements (e.g., voice, text, images, etc.) can be important for various audio-only and/or audio/visual applications. For example, in oral presentations, temporal alignment of audio (e.g., from a presenter's voice) and text (e.g., from a displayed presentation script) could drive functions including: (1) providing responsive presentation text hints and/or prompts; (2) automatically initiating dynamic effects and events in response to achieving pre-defined times and/or triggers in scripts, etc. Some conventional temporal media alignment approaches resolve this problem based on text alignment. For example, conventional approaches first transcribe the audio input into text and then apply a text to text alignment algorithm. However, such methods can suffer from transcription errors, especially for words and sentences with mixed languages, technical/specialized language, or numbers, dates, etc. Such methods may also produce errors in cases of different textual words (with different meanings) that are pronounced the same (e.g., homophones) and/or textual words that are identical but have different pronunciations (with associated different meanings). Accordingly, improved ways to temporally align media elements are desirable.

### SUMMARY

The present disclosure describes systems and methods that provide temporally-aligned text prompts (e.g., displayed text script) with an audio input (e.g., a speaker's voice). Such temporal alignment is based on specific features of the audio input (e.g., voice characteristics) instead of techniques that use direct text matching by way of a voice-to-text transcription. Such systems and methods can greatly increase the alignment speed, accuracy, and stability.

In a first aspect, a system is described. The system includes a microphone configured to receive an audio input and provide an audio input waveform and a text input interface configured to receive text input. The system also includes an audio feature generator comprising a text-to-speech module configured to convert the text input to a text-to-speech input waveform. The system further includes an audio feature extractor configured to extract characteristic audio features from the audio input waveform and the text-to-speech input waveform. The system yet further includes an alignment module configured to compare audio input waveform features and text-to-speech waveform features so as to temporally align a displayed version of the text input with the audio input.

In a second aspect, a method is described. The method includes providing an audio input waveform based on an audio input and receiving a text input. The method also includes converting the text input to a text-to-speech input waveform and extracting, with an audio feature extractor, characteristic audio features from the audio input waveform and the text-to-speech input waveform. The method yet further includes comparing audio input waveform features and text-to-speech waveform features. The method additionally includes based on the comparison, temporally aligning a displayed version of the text input with the audio input.

These as well as other embodiments, aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

FIG. 1 illustrates a system, according to an example embodiment.

FIG. 2 illustrates an operating scenario, according to an example embodiment.

FIG. 3 illustrates an operating scenario, according to an example embodiment.

FIG. 4 illustrates an operating scenario, according to an example embodiment.

FIG. 5 illustrates a method, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. Overview

Properly aligning spoken audio with a corresponding text script should be irrelevant of the semantics of the underlying text. That is, temporal alignment of audio and text need not be based on any particular meaning of the text. Rather, the temporal alignment of the text and audio should be most efficiently based on matching audio sounds. The main benefits of this approach is that it does not require a translation between audio input and text script, which avoids possible translation errors. For example, in conventional methods that utilize automatic speech recognition (ASR), if ASR fails to recognize the spoken audio, it generates some irrelevant text or may even leave the text blank. This speech to text translation introduces a systemic error. In the present disclosure, systems and methods are described that perform the audio and text alignment without understanding a semantic meaning of words in the audio input.

Example systems include an audio feature extractor configured to extract characteristic features from the audio input waveform. Such systems also include an audio feature generator that utilizes a text-to-speech module to convert the text input into a text-to-speech input waveform. The system also includes an alignment module configured to temporally align the audio input waveform features with the text-to-speech waveform features so as to provide a displayed version of the text input that is temporally synchronized with the audio input.

### II. Example Systems

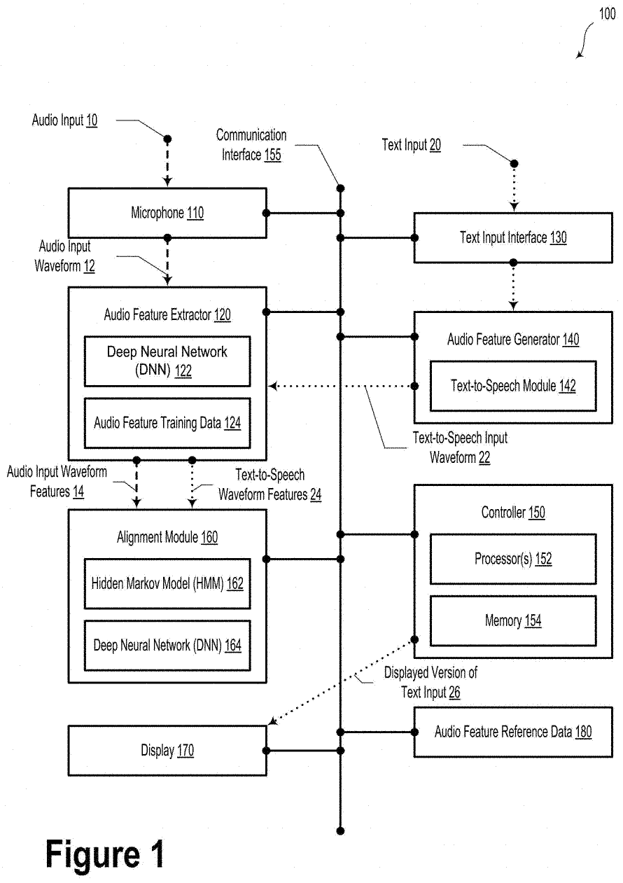

FIG. 1 illustrates a system 100, according to an example embodiment. System 100 includes a microphone 110 configured to receive an audio input 10 and provide an audio input waveform 12. In some embodiments, system 100 need not include microphone 110. For example, various elements of system 100 could be configured to accept audio input 10 and/or audio input waveform 12 from, e.g., pre-recorded audio media.

System 100 includes a text input interface 130 configured to receive a text input 20. In some embodiments, system 100 need not include text input interface 130. For example, various elements of system 100 could be configured to receive text input 20 from, e.g., a pre-existing text file.

System 100 also includes an audio feature generator 140 comprising a text-to-speech module 142 that is configured to convert the text input 20 to a text-to-speech input waveform 22.

System 100 additionally includes an audio feature extractor 120 configured to extract characteristic audio features (e.g., audio input waveform features 14 and text-to-speech waveform features 24) from the audio input waveform 12 and the text-to-speech input waveform 22. In some examples, the audio feature extractor 120 could include a deep neural network (DNN) 122 configured to extract the characteristic audio features based on a windowed frequency graph of the audio input waveform 12 or the text-to-speech input waveform 22. In such scenarios, the DNN 122 could be trained based on audio feature training data 124. Furthermore, the DNN 122 could be configured to extract the characteristic audio features without prior semantic understanding.

In some embodiments, the characteristic features could be extracted from a source other than the audio input waveform 12 and/or the text-to-speech input waveform 22. For example, the audio input waveform 12 and/or the text-to-speech waveform could be converted to another datatype and the characteristic features could be extracted from that other source. Additionally or alternatively, various text sound features could be extracted directly from text input 20 by using lookup dictionaries or other text reference source. In other words, some embodiments need not utilize conventional text-to-speech methods.

System 100 yet further includes an alignment module 160 configured to compare audio input waveform features 14 and text-to-speech waveform features 24 so as to temporally align a displayed version of the text input 26 with the audio input 10. In various embodiments, the alignment module 160 could include at least one of: a Hidden Markov Model 162, a deep neural network (DNN) 164, weighted dynamic programming model, and/or a recurrent neural network (RNN), which may be utilized to temporally align the displayed version of the text input 26 with the audio input 10. In such scenarios, the alignment module 160 could be further configured to determine a temporal match based on a comparison between audio input waveform features, text-to-speech waveform features, and a predetermined matching threshold.

In some example embodiments, the audio input waveform features 14 and/or the text-to-speech waveform features 24 could generally be characterized as “sound features.” In such scenarios, the alignment module 160 could be configured to compare the sound features extracted from audio input waveform and sound features extracted from the text input 26 so as to temporally align a displayed version of the text input 26 with the audio input 10.

In some examples, system 100 could additionally include a display 170 configured to display the displayed version of the text input 26.

In example embodiments, system 100 could also include audio feature reference data 180. In such scenarios, at least one of: the audio feature extractor 120, the audio feature generator 140, and/or the alignment module 160 are configured to utilize the audio feature reference data 180 to perform its functions. In some examples, the audio feature reference data 180 could include at least one of: international phonetic alphabet (IPA) audio features, Chinese Pinyin audio features, or Sound waveform related features.

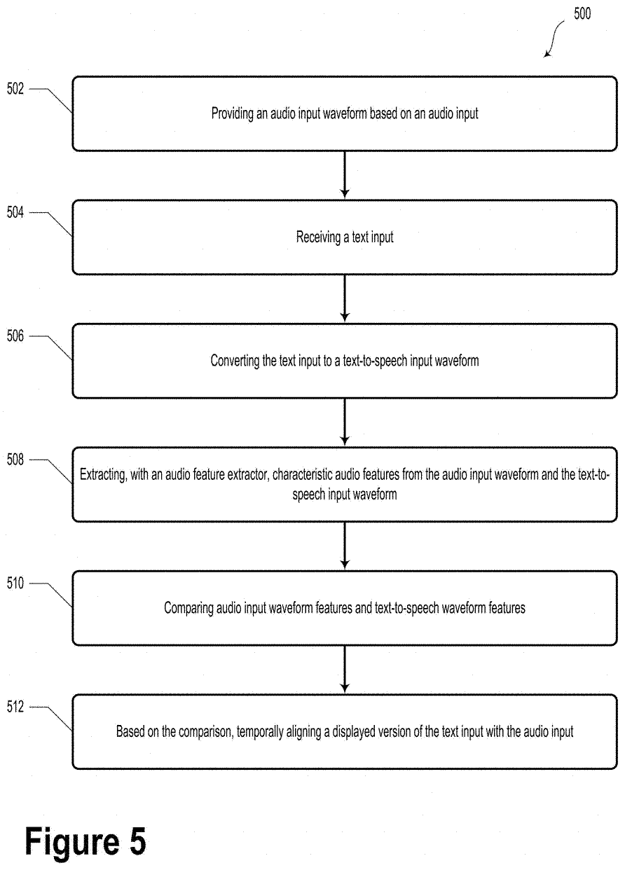

Additionally or alternatively, system 100 could include a controller 150 having at least one processor 152 and a memory 154. In such scenarios, the at least one processor 152 executes instructions stored in the memory 154 so as to carry out instructions. The instructions could include operating at least one of: the audio feature extractor 120, the audio feature generator 140, the alignment module 160, and/or the display 170. In some embodiments, controller 150 could be configured to carry out some blocks of or all blocks of method 500, as described and illustrated in relation to FIG. 5.

A. Voice Feature Sequence

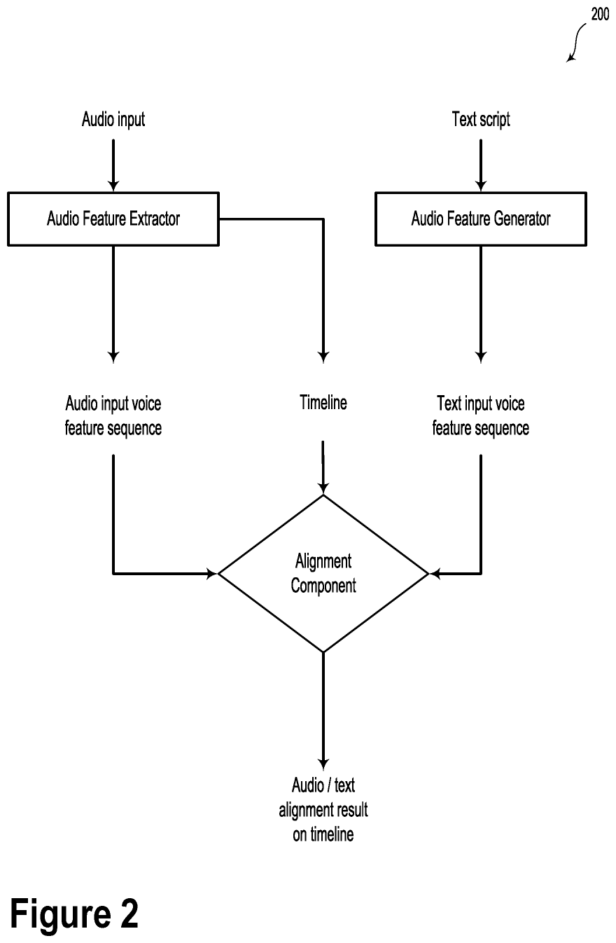

FIG. 2 illustrates an operating scenario 200, according to an example embodiment. An important element of the present system and related methods is the conversion of an audio input and a text input script into a common voice-based feature sequence. The voice feature sequence has the following features:

Audio, as long as it sounds similar, has similar voice features. Otherwise, it has different voice features.

Text, as long as it is pronounced similarly, has similar voice features. Otherwise, it has different voice features.

Several example voice features that could be used in this system include International Phonetic Alphabet (IPA), Pinyin for Chinese, Sound waveform related features, Sound frequency distribution, Sound length, Sound emphasis, among other possibilities.

B. Audio Input to Voice Feature Sequence

As shown in the exemplary operation scenario 200, an audio input (for example, audio input 10 in FIG. 1) is input to an audio feature extractor (for example, audio feature extractor 120 in FIG. 1), and conversion of the audio input into audio input voice feature sequence is finished therein.

That is, converting an audio input into an audio input voice feature sequence could be accomplished through an audio feature extractor that utilizes an artificial intelligence algorithm, such as a Deep Neural Network (DNN). An example system could utilize a Convolutional Neural Network (CNN) using windowed frequency graphs as inputs to generate a voice feature sequence from the audio waveforms. Additionally or alternatively, example systems and methods could utilize other ways to extract sound features like Mel-frequency cepstral coefficients (MFCC) features, among other possibilities.

To create a such Audio Feature extractor based on CNN, the model could be trained in the following way:

Collect audio/voice feature pair. Voice features could include one or more of: IPA sequences, pinyin sequences, among other alternatives described herein.

Audio/speech feature pair instances feed in to Deep Neural Network and update the parameters during a training phase.

Utilize the trained model to provide audio waveform features based on the audio input and the text-to-speech.

The key difference between the present Deep Neural Network model and other conventional methods is that conventional methods utilize prior semantic understanding, which makes the model more complex and can produce errors. The present model only utilizes audio waveforms to perform voice feature classification without understanding the real semantic meaning. As such, presently described systems and methods will greatly reduce model complexity and neural network learning difficulties.

C. Text to Voice Feature Sequence

As shown in the exemplary operation scenario 200, a text input (for example, the text input 20 in FIG. 1) is input to an audio feature generator (for example, the audio feature generator 140 in FIG. 1), and conversion of the text input into text input voice feature sequence is completed therein.

Converting a text sequence to a text input voice feature sequence could be accomplished through several ways, which may depend on the choice of a desired type of characteristic voice features.

For IPA or Pinyin, etc, standard language dictionaries created by human professionals could be used for directly search-and-replace. For voice feature sequences like sound waveforms, methods in the Text-to-Speech (TTS) field could be utilized. Recent developments in this field, including Google's Deep Neural Network Tacotron 2 TTS framework can provide outstanding human-like sounds based on text input after proper training. Based on those generated sounds, we could use similar methods introduced in audio input for voice feature sequence extraction. Note that utilizing these techniques means that there is little ambiguity in converting text to speech under the present disclosure.

D. Sequence to Sequence Alignment

As shown in the exemplary operation scenario 200, subsequent to obtaining voice feature sequences from the audio and text inputs, an alignment module can be used to obtain audio/text alignment results on the timeline to temporally-align adjusted display text with the audio input.

Because the audio and text inputs form data sequences, a common way to temporally align the two sequences is through weighted dynamic programming. For example, gains/penalties could be assigned to each pair of audio and text-to-speech features. Gains and penalties could be similar to the Damerau-Levenshtein distance (e.g., a metric that measures the edit distance between two sequences). Additionally or alternatively, for matching two temporal sequences, dynamic time warping (DTW) could be used. More specifically, a weighted table of each pair of voice features could be determined. Generating such a weighted table of voice feature pairs could be performed as follows. Step 1: initially, the table could be created manually based on a subjective measure of how far apart in time a sound feature is from its pair. As an example, the manual creation of the table could be based on e.g., user trial/error and/or user input. Step 2: based on a large plurality of inputs, the probabilities of mistaking the temporal distance between pairs could be determined. In such scenarios, the table could be updated iteratively so as to correctly estimate the temporal distance between sounds that are easily mistaken. The weights within the table represent the similarity of the sound between corresponding pairs of voice features. Then, a dynamic programming alignment process can be carried out, iterating all possible alignment combinations with the weighted table. Subsequently, the best temporal alignment with the maximum sum of weights can be determined. Note that this method allows certain misalignment at certain location, as long as the alignment over the entire sequence, or a portion of the sequence, is maximized.

Systems and methods described herein could utilize Hidden Markov Model (HMM)-based alignment methods. In such a scenario, a state machine could be created based on text voice features and a probability could be assigned between state transitions upon receiving voice features from audio.

Additionally or alternatively, a Deep Neural Network could be utilized to perform sequence alignment. Common models include recursive neural network (RNN) based models, such as long short-term memory (LSTM) methods, among others.

If the audio is received as a stream (instead of pre-recorded resources), during the application of the above methods, the system may continuously output an alignment position of the latest (e.g., most current) input audio. As a result, there may be few updates of the above matching methods.

The matching problem size will dynamically reduce to a shorter version consisting of the sequences that are not yet matched.

Since only an initial segment of audio input is obtained, the initial audio segment need not be matched (or compared) to the whole unmatched text sequence. Rather, text voice features at the very beginning of the text-to-speech sequence could be assigned a higher weight, and the weights decrease through the voice feature sequence for text.

Since it may not be known precisely how the text-to-speech voice features will match the short piece of input audio voice features, systems and methods described herein could assign a matching threshold to determine whether there is a match for streaming audio voice feature sequence input to the text voice feature sequence or not among different text voice feature sequence candidates. The matching threshold could be defined by one or more of: (1) manually setting a heuristic number; (2) collecting a plurality of audio inputs and corresponding text-to-speech voice dataset, run the streaming match algorithm and select a threshold where e.g., 99% percent of the matched script and voice dataset are chosen correctly in such dataset; (3) similar to method 2, a different threshold could be assigned for cut-off locations according to some heuristic information. For example, whenever there is punctuation (e.g., a comma or period) in the text input, we could give a lower threshold to cut-off at that point of the sequence; (4) Voices recorded by a specific person could be collected. In such a scenario, the habits of his/her reading (e.g., vocal/speaking characteristics) could be determined, which could make better threshold adjustments above. Such a learning method could include a supervised learning technique.

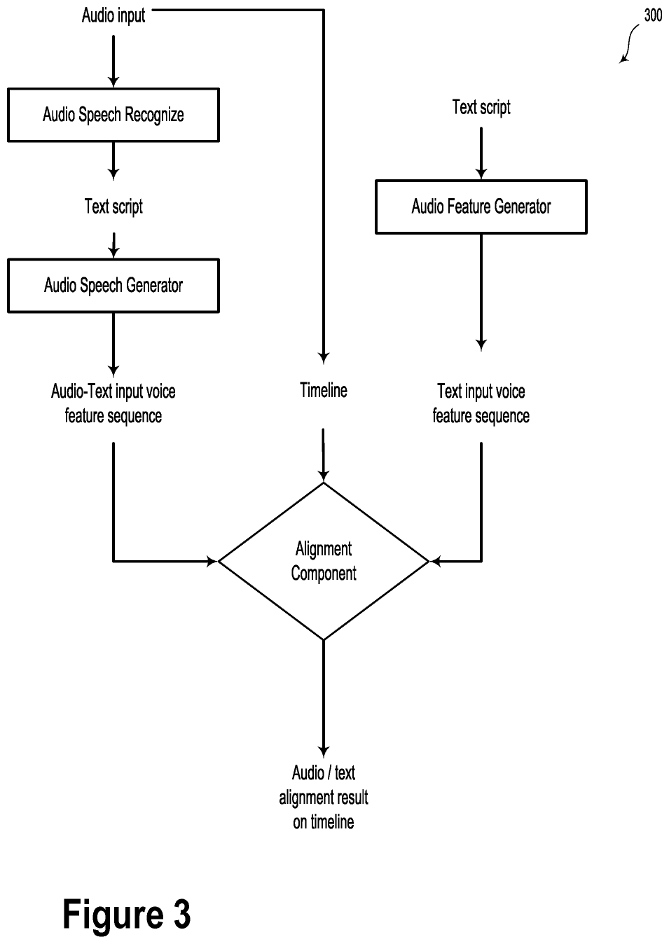

FIG. 3 illustrates an operating scenario 300, according to an example embodiment. The operation steps in the operation scenario 300 are basically the same as those in the operation scene 200. The only difference is that: in the operation scenario 200, it is described that the audio input can be directly converted into audio features, but in the operation scenario 300, the voice recognize module can be used to convert the audio input into a text script, and the text script can be converted into an audio-text input voice feature sequence using an audio feature generator including a text-to-speech module. Then, similar to in the exemplary operation scenario 200, after obtaining the voice feature sequence from the audio and text input respectively, the alignment module can be used to obtain the audio/text alignment result on the timeline, so as to display the aligned part of the text script corresponding to the audio input. To simplify the descriptions, the steps in the operation scenario 300 that are the same as those in the operation scenario 200 are not repeatedly described. It can be seen from the operation scenario 300 that the technical solution of the present disclosure is compatible with existing systems that need to first convert audio input into text.

E. Teleprompter Application

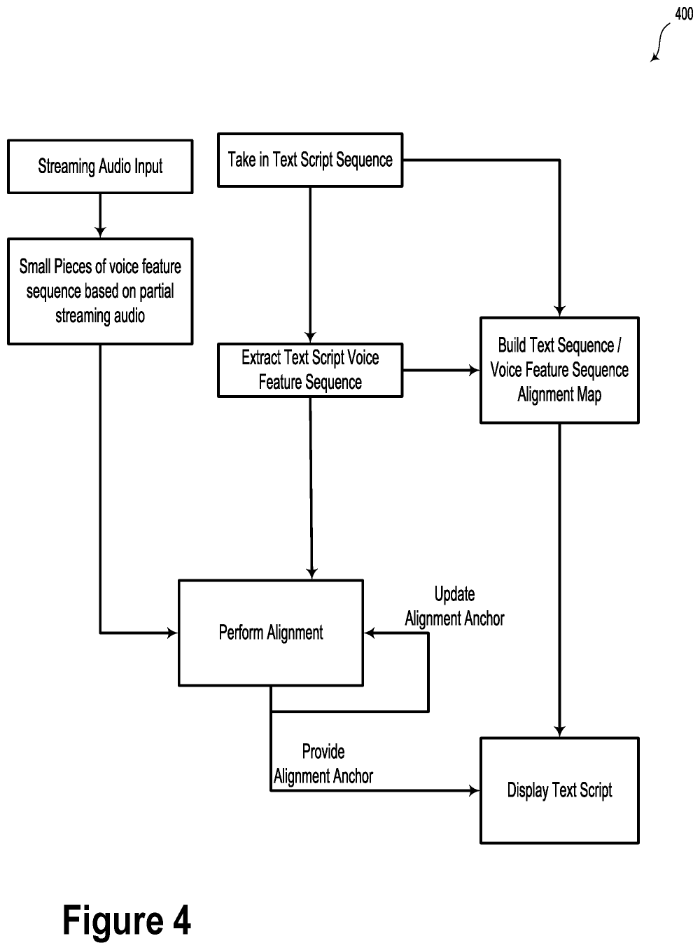

FIG. 4 illustrates an operating scenario 400, according to an example embodiment.

Systems and methods could be utilized in various applications such as a teleprompter application.

Such a system could include a microphone configured to receive audio inputs and provide audio waveforms. The system could also include a monitor (e.g., a display) for displaying text hints/prompts and a controller to process the audio waveform and text alignment.

In operation scenario 400, the overall pipeline in the teleprompter application could be as following:

Step 1: take in text script sequence.

Step 2: extract text script voice feature sequence.

Step 3: Take in streaming input audio (e.g., audio from the speaker) and dynamically convert it to a voice based features streaming sequence.

Step 4: Convert the streaming audio input into small pieces of voice feature sequence based on partial steaming audio.

Step 5: Perform alignment of the voice feature sequence of the text script extracted in step 2 with the small pieces of voice feature sequence based on the partial streaming audio obtained in step 4 and find the text location corresponding to the latest (e.g., most recent) audio waveform input. After the current alignment is completed, an alignment anchor is provided to the display, and then its own alignment anchor is updated.

Step 6: On the monitor, display the text script corresponding to the audio input. Specifically, at the beginning, the next sentence that has not been aligned in time can be displayed, and then the displayed sentence can be updated by either scrolling the script text down on the display screen, or changing the text displayed directly on the screen. The display and update can be based on the text sequence-speech feature sequence alignment map built in step 6.

Other features could be added to this teleprompter application, including the function to receive voice instructions like “go back to the last sentence”, “skip to next sentence”, “go back to previous section”, “skip to next section”, “restart presentation”, “stop presentation”, etc.

### III. Example Methods

FIG. 5 illustrates a method 500, according to example embodiments. It will be understood that the method 500 may include fewer or more steps or blocks than those expressly illustrated or otherwise disclosed herein. Furthermore, respective steps or blocks of method 500 may be performed in any order and each step or block may be performed one or more times. In some embodiments, some or all of the blocks or steps of method 500 may be carried out by controller 150 and/or other elements of system 100 as illustrated and described in relation to FIGS. 1, 2, 3, and 4.

Block 502 includes providing an audio input waveform (e.g., audio input waveform 12) based on an audio input (e.g., audio input 10).

Block 504 includes receiving a text input (e.g., text input 20).

Block 506 includes converting the text input to a text-to-speech input waveform (e.g., text-to-speech input waveform 22).

Block 508 includes extracting, with an audio feature extractor (e.g., audio feature extractor 120), characteristic audio features (e.g., audio input waveform features 14 and/or text-to-speech waveform features 24) from the audio input waveform and the text-to-speech input waveform, wherein the characteristic audio features may include audio input waveform features and text-to-speech waveform features. In various examples, extracting the characteristic audio features could include utilizing a deep neural network (DNN) to extract the characteristic audio features based on a windowed frequency graph of the audio input waveform or the text-to-speech input waveform. In some examples, the DNN could be trained based on audio feature training data. Additionally or alternatively, the DNN could be configured to extract the characteristic audio features without prior semantic understanding.

Block 510 includes comparing audio input waveform features and text-to-speech waveform features. In an alternative embodiment, the comparing may include comparing audio input waveform characteristics, text-to-speech waveform characteristics, with a predetermined matching threshold.

Block 512 includes, based on the comparison results, temporally aligning a displayed version of the text input (e.g., displayed version of the text input 26) with the audio input. In such scenarios, temporally aligning the displayed version of the text input with the audio input could utilize an alignment module comprising at least one of: a Hidden Markov Model, a deep neural network (DNN), or a recurrent neural network (RNN), which could be configured to temporally align the displayed version of the text input with the audio input. In some embodiments, temporally aligning the displayed version of the text input with the audio input could include determining a temporal match based on a comparison between audio input waveform features, text-to-speech waveform features, and a predetermined matching threshold.

In some embodiments, the method 500 may further include displaying, by a display (e.g., display 170), the displayed version of the text input.

In various examples, the method 500 may additionally include receiving, by a microphone (e.g., microphone 110), the audio input.

Method 500 may further include receiving audio feature reference data (e.g., audio feature reference data 180). At least one of: the converting step (e.g., block 506), the extracting step (e.g., block 508), or the comparing step (block 510) are performed based, at least in part, on the audio feature reference data. In some embodiments, the audio feature reference data could include at least one of international phonetic alphabet (IPA) audio features, Chinese Pinyin audio features, or sound waveform related features.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

1. A system for audio and text alignment comprising:
an audio feature generator comprising a text-to-speech module configured to convert a text input to a text-to-speech input waveform;
an audio feature extractor configured to extract characteristic audio features from an audio input waveform and the text-to-speech input waveform;
an alignment module configured to compare characteristic audio features extracted from the audio input waveform and characteristic audio features extracted from the text-to-speech waveform so as to temporally align a displayed version of the text input with the audio input.

2. The system of claim 1, further comprising:
a microphone configured to receive an audio input and provide the audio input waveform;
a text input interface configured to receive the text input; and
a display configured to display the displayed version of the text input.

3. The system of claim 1, further comprising:
audio feature reference data, wherein at least one of: the audio feature extractor, the audio feature generator, or the alignment module are configured to utilize the audio feature reference data.

4. The system of claim 3, wherein the audio feature reference data comprises at least one of:
international phonetic alphabet (IPA) audio features;
Chinese Pinyin audio features; or
Sound waveform related features.

5. The system of claim 1, wherein the audio feature extractor comprises:
a deep neural network (DNN) configured to extract the characteristic audio features based on a windowed frequency graph of the audio input waveform or the text-to-speech input waveform.

6. The system of claim 5, wherein the DNN is trained based on audio feature training data.

7. The system of claim 5, wherein the DNN is configured to extract the characteristic audio features without prior semantic understanding.

8. The system of claim 1, wherein the alignment module comprises at least one of:
a Hidden Markov Model;
a deep neural network (DNN); or
a weighted dynamic programming model; to temporally align the displayed version of the text input with the audio input.

9. The system of claim 1, wherein the alignment module is further configured to determine a temporal match based on a comparison between audio input waveform features, text-to-speech input waveform features, and a predetermined matching threshold.

10. The system of claim 1, further comprising a controller having at least one processor and a memory, wherein the at least one processor executes instructions stored in memory so as to carry out instructions, the instructions comprising:
operating at least one of: the audio feature extractor, the audio feature generator, the alignment module, or the display.

11. A method for audio and text alignment comprising:
providing an audio input waveform based on an audio input;
receiving a text input;
converting the text input to a text-to-speech input waveform;
extracting, with an audio feature extractor, characteristic audio features from the audio input waveform and the text-to-speech input waveform;
comparing audio input waveform features and text-to-speech input waveform features; and
based on the comparison, temporally aligning a displayed version of the text input with the audio input.

12. The method of claim 11, further comprising:
displaying, by a display, the displayed version of the text input.

13. The method of claim 11, further comprising:
receiving, by a microphone, the audio input.

14. The method of claim 11, further comprising:
receiving audio feature reference data, wherein at least one of: the converting step, the extracting step, or the comparing step are performed based, at least in part, on the audio feature reference data.

15. The method of claim 14, wherein the audio feature reference data comprises at least one of:
international phonetic alphabet (IPA) audio features;
Chinese Pinyin audio features; or
Sound waveform related features.

16. The method of claim 11, wherein extracting the characteristic audio features comprises:
utilizing a deep neural network (DNN) to extract the characteristic audio features based on a windowed frequency graph of the audio input waveform or the text-to-speech input waveform.

17. The method of claim 16, wherein the DNN is trained based on audio feature training data.

18. The method of claim 16, wherein the DNN is configured to extract the characteristic audio features without prior semantic understanding.

19. The method of claim 11, wherein temporally aligning the displayed version of the text input with the audio input comprises utilizing an alignment module comprising at least one of:
a Hidden Markov Model;
a deep neural network (DNN); or
a recurrent neural network (RNN); to temporally align the displayed version of the text input with the audio input.

20. The method of claim 11, wherein temporally aligning the displayed version of the text input with the audio input comprises determining a temporal match based on a comparison between audio input waveform features, text-to-speech input waveform features, and a predetermined matching threshold.
